(19) United States
(12) Patent Application Publication
(10) Pub. No.: US 2012/0289753 A1
(43) Pub. Date: Nov. 15, 2012

(54) METHOD AND INSTALLATION FOR COMPLETE RECYCLING THROUGH DEPOLYMERISATION

(76) Inventors: Victorino Luengo Marin, Tarragona (ES); Javier Guilarte Saen, Tarragona (ES)

(21) Appl. No.: 13/519,726

(22) PCT Filed: Nov. 25, 2010
(86) PCT No.: PCT/EP10/07156

§ 371 Date: Jun. 28, 2012

(30) Foreign Application Priority Data
Dec. 30, 2009 (ES) P2010000027

(51) Int. Cl. C08J 11/04; C08J 11/10; C10B 57/12; C01B 31/00; C10G 1/00

(52) U.S. Cl. 585/240; 423/449.1; 420/591; 202/84; 201/4; 201/2.5; 123/1 A

(57) ABSTRACT

The present invention relates to the recycling by depolymerisation through thermolysis. A method and installation for depolymerisation through efficient thermolysis for recycling is provided that allow the production of light hydrocarbons having high quality and being free of impurities and contaminants. This objective is achieved by methods and installations where either the secondary products of the process are re-fed to supply energy for the main recycling process or are refined to manufacture final usable and saleable products. Therefore, the use of the energy content of the starting materials is maximised by assuring their full utilisation, minimising the environmental harm while an energetically autonomous installation is provided. All the components of the waste or starting material may be recycled, by physico-chemical means, and no additional contaminant waste is produced.

### TECHNICAL FIELD

The present invention refers generally to the field of recycling by depolymerisation, and in particular by depolymerisation through thermolysis, where the starting materials are fully recycled, either by re-feeding part of the secondary products to supply energetically the depolymerisation or by refining part of the secondary products to obtain solid, liquid and gaseous final products suitable for consumption or sale.

### BACKGROUND OF THE INVENTION

The huge consumption of products made from materials of organic origin such as rubbers, tires, plastics and the like as well as the waste of such materials formed during manufacture processes is causing big problems with respect to storage and destruction. Besides the high costs involved, also ecologic and environmental consequences have to be considered. In the meantime, some countries have experienced such huge problems with the storage and destruction of these materials that investigation is now carried out for studying the search for and the possibility of using oceanic trenches as places of storage. The same may be said with respect to storage and destruction of oxidised oils.

In the prior art, several methods for the treatment or destruction of rubbers, tires, plastics and the like are described. Such methods comprise the recycling by retreading, grinding, gasification, controlled or uncontrolled combustion (incineration), wholly treated, cryogenic systems (tyrolysis) etc. However, all these methods show some disadvantages and are not suitable for fully recycling the components present in said waste materials. Whole tires are abandoned in dumps which is not considered an appropriate solution given the high energetic value still contained in such materials.

The recycled materials obtained with the above-mentioned methods may represent added value but these resulting products still are of poor quality. The grinded materials may be buried in controlled dumps or mixed with asphalt to be used later for paving. Alternatively, such materials may also be milled until granulates of different particle sizes are obtained, and may be used for incineration in cement furnaces (milled) or be a component of children's parks or sport fields (milled to micron scale). The cryogenic systems (tyrolysis) are used to separate the metal part from the rest of the organic material, which is then burned as furnace combustible. However, this direct combustion leads to contaminating effluent gases, since not all the additives have been eliminated and valuable solid compounds cannot be recovered.

Pyrolysis represents a method for recycling of hydrocarbons present in the waste materials by cracking the carbon chains of the organic compounds making up said materials. The dry distillation of plastics, rubbers and tires is known in the state of the art. However, only heavy hydrocarbons in low yields are obtained and even new residues are produced which require to be treated. Sometimes, pyrolysis produces only hydrocarbons and little carbon black can be obtained. Hence, the pyrolysis of the state of the art is not very well suited for recycling waste materials and their transformation into high quality products.

Moreover, pyrolysis uses typically high temperatures between 500 and 1000° C. Plants using said temperatures need a costly installation that resists to these high temperatures and it must be secured that no temperature loss occurs causing an insufficient heating. This inefficiency produces a waste of energy and the method being generally more expensive.

An improvement over this kind of pyrolysis at high temperatures comprises the pre-treatment with oil to separate the metallic components in one phase. In another phase, the carbon black obtained is washed with ether to separate the inorganic impurities. However, this improvement requires more treating steps and more devices in the installation which prevent an even more direct recycling. Correspondingly, more residues are produced and, given the additional phases, the installation is more expensive. Moreover, working with a ether solvent requires very strict safety regulations due to its high inflammability, narcotic effect and potential of transforming into an explosive derivative in the presence of oxygen.

Therefore, the existing systems represent low efficient recycling processes resulting in secondary residue products that contain an important stored energy value which is not reused. Moreover, some of these secondary products also are simply thrown away into the environment. None of the methods has been sufficiently efficient and convincing to not only eliminate the residue but further to obtain a use, in this case energetic, of the residues which at the moment cause big damages to us.

### SUMMARY OF THE INVENTION

The object of the present invention is to provide a depolymerisation method and installation for recycling by efficient thermolysis that allows the production of light hydrocarbons having high quality and being free from impurities and contaminants. This object is achieved by methods and installations where the secondary products of the process either are re-fed to supply energy for the main recycling process or refined to produce final usable and saleable products. Hence, the use of the energy content of the starting materials is maximised assuring their complete utilisation, minimising the environmental harm while an energetically autonomous installation is provided.

The herein disclosed invention allows advantageously the transformation of voluminous residues into final products of high energy value and with a better yield, typically a yield higher than 95% of the total. Contrary to the pyrolysis of the state of the art, the herein disclosed thermolysis allows to obtain perfectly consumable products in important amounts having a strong added value with the corresponding economic repercussion for crude importing countries. The hydrocarbons obtained with the thermolysis herein disclosed have superior properties than the products of the same characteristics obtained with the best light-petroleum because according to their density, they are practically equal but during their transformation, additionally to other products, fuel oil is obtained, which is not produced in our invention, so that the yield of diesel oil is higher.

Therefore, by means of the depolymerisation of the present invention the waste materials are recycled by thermolysis and purification of the solid, liquid and gaseous secondary products. All of the components of the waste or starting material can be recycled by physico-chemical means and no additional contaminant waste is produced. The preferred starting materials are tires, plastics, rubbers or multi component waste materials such as cables. Other starting materials may be oils, such as for example heavy oils, fuel oil or oxidised oil, or other organic biological material. The organic mass of the components of the starting materials is transformed into products like gaseous hydrocarbons, liquid hydrocarbons and asphaltic bitumen. Preferably, the products are selected from the group comprising metal, gaseous hydrocarbons, liquid hydrocarbons, solid hydrocarbons (waxes or tar), inorganics and carbon black (from carbon). The isolated solids like the metal oxides, tar, carbon black etcetera are characterised by being the filler or additive accompanying the polymer depending on the manufacturer, being their proportions different.

Another object of the present invention is the production of gaseous hydrocarbons, liquid hydrocarbons of high quality and solid products of high quality, and to reuse all the recovered products. Another object of the present invention is the use of said products in several determined applications.

The liquid hydrocarbons for sale may be gasoline or diesel oil of different qualities. These products may have various applications and use. For example, they may be used as combustible for the co-generation of energy, in industrial and automobile engines, and in furnaces. Also, they may be used as feedstock in the chemical industry.

The solid products for sale may be carbon black as well as the iron of the tires. The metallic products are sold directly while the carbon black may have various applications and use. Generally, it is used as a pigment or reinforcing material. It may also be used for asphaltic applications or mixtures, for the manufacture of master batches with polymeric products utilised in extrusions, injection and pressing of the plastics and rubbers or for its transformation into activated carbon. The activated carbon may then be used as a filtering agent or adsorbent in various applications of purification or also in medicine.

Another object of the present invention is to provide an installation for carrying out the depolymerisation comprising one or more thermolysis reactors equipped with a cracking column in the upper part, means for purifying the obtained products, and means for providing energy to the installation using the thermolysis products.

Another object of the present invention is to achieve the energetic autonomy of a recycling method by feeding the burner with the products of said recycling method. Preferably, the burner is fed with gaseous hydrocarbons. Alternatively, said burner may be additionally fed with liquid hydrocarbons and/or carbon black. The heat coming from the burner is utilised for heating the thermolysis reactor.

Another object of the present invention is to achieve an increase in the production of carbon black, until reaching the double of the content of the carbon black that we had before.

In the context of the present invention, the term “waste materials” means material that has been manufactured, used in industry or households and then thrown away or disposed of in any other way. However, it may also comprise materials that are leftovers of production processes or items of such a bad quality that they are directly thrown away after their manufacture. The waste materials may comprise residues of cables, old tires, containers of food products or household products, packaging or any other polymer-based material having a higher yield. Said waste materials are of use as starting material in the present invention.

In the context of the present invention, the term “crack”, “cracked” or “cracking” refers to a thermal or catalytic chemical reaction which is normally used in the refining method of petroleum. “Cracked” or “cracking” means the decomposition or depolymerisation of the organic molecules, which preferably comprise long carbon chains, into smaller and/or shorter molecules. In the context of the present invention, the term “depolymerisation” means the decomposition of carbon chains in shorter fragments by either catalytically or thermally induced reactions.

In the context of the present invention, the term “thermolysis” refers to a chemical reaction heat treatment wherein a compound is separated in at least two when subjected to a temperature increase, the compound not being in contact with the torch. Given that it is an endothermic reaction, the thermolysis requires the contribution of heat to break the chemical bonds. The decomposition temperature is set so that this process can take place. In the context of the present invention, the terms “cracking”, “depolymerisation”, and “thermolysis” may have the same meaning.

In the context of the present invention, the term “secondary product” means a product of a reaction, process or method that results being a transformed compound for internal use or that needs being subjected to more processes or methods, preferably refining, to obtain a final product of high quality for external use and/or for sale. Hence, in the context of the present invention, the term “final product” means a refined product for external use which is suitable to be sold and/or used.

In the context of the present invention, the term “material of organic nature” refers to materials, products or articles based on polymers. This “material of organic nature” may comprise synthetic or natural polymers, preferably synthetic polymers. More preferably, the “material of organic nature” comprises compounds showing a hydrocarbon structure with low oxygen content. The waste materials comprise materials of organic nature.

The present invention is now further described by the annexed figures and claims. Like reference numerals indicate like elements.

### FIGURES

FIG. 1—shows a general overview of the present invention.

FIG. 2—shows another general overview of the present invention.

FIG. 3—represents the main steps of the pre-treatment of the initial material.

FIG. 4—represents the main steps of the pre-treatment comprising the digestion in oil.

FIG. 5—shows another general overview of the present invention.

FIG. 6—represents the first steps of the refining of the gaseous and liquid hydrocarbons secondary products.

FIG. 7—represents the refining of the gaseous secondary products.

FIG. 8—represents the refining of the liquid secondary products.

FIG. 9—represents the refining of the solid secondary products.

FIG. 10—represents the refining of the solid secondary products comprising the dissolution in oil.

FIG. 11—represents a flow chart of the installation according to one embodiment.

FIG. 12—represents a flow chart of the installation according to another embodiment comprising the digestion in oil.

FIG. 13—represents a flow chart of the installation according to another embodiment comprising the dissolution in ether.

FIG. 14—represents a flow chart of the installation according to another embodiment comprising digestion in oil and dissolution in ether.

### DETAILED DESCRIPTION OF THE INVENTION

In the prior art recycling systems are described which are hardly efficient and result in secondary residue products containing an important stored energy value that is not reused. Moreover, some of these secondary products also are simply thrown away into the environment and an important source of energy is lost. Other systems simply burn the waste materials with all contained additives resulting in contaminant effluent gases. Other methods just consist in storing the waste materials in dumps and besides occupying large space they contaminate the environment.

The present invention solves the above-mentioned problems and has additional advantages by providing a recycling method and system comprising the steps of:
depolymerising polymer-based starting materials by thermolysis in a reactor, wherein the reactor is heated indirectly;
separating the solid, liquid and gaseous secondary products;
returning a part of the obtained secondary products to supply energy to the reactor; and
processing the remaining parts of the secondary products to manufacture final products suitable for external use;
wherein all the polymer-based starting material is either consumed by re-feeding to the reactor or refined to obtain solid, liquid and gaseous final products suitable for the consumption or sale.

In all the described embodiments, it is understood that all described characteristics may be either method characteristics or characteristics describing the elements of an installation or system. Hence, in the description product characteristics as well as the necessary methodology to carry out the method for the product are disclosed interchangeably. If only a method is mentioned, it is understood that an apparatus, element, system, installation or means to carry out the method are also comprised in the description and it would be clear to the skilled in the art to derive one from the other.

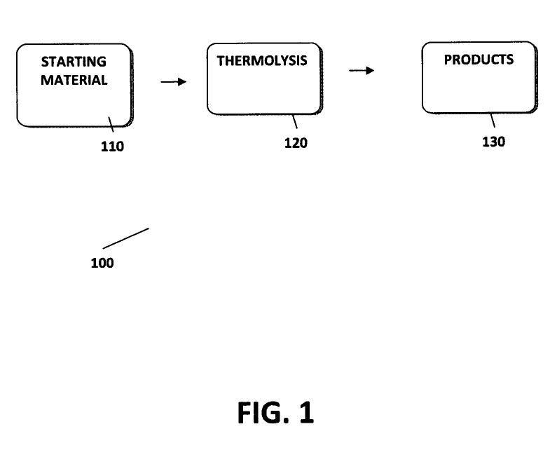

Referring to FIG. 1, in one embodiment, the method comprises the sequence of providing the starting materials 110, the thermolysis 120 of said materials and isolating the thermolysis products 130.

As starting material 110, any material of organic nature may be used that can be subjected to the depolymerisation. In one embodiment, the starting materials 110 comprise tires, rubbers, plastics, cables, cellulose, cellophane, nylon, oils, biological materials originating from plants or mixtures of the same. The tires are selected from the group comprising the ones commonly used in automation, transport and for industrial machines. The rubbers are selected from the group comprising natural, synthetic and reinforced rubber. In particular, the rubber may comprise butadiene, butadiene-styrene, chloroprene, elastomers, fluoroelastomers, and the like. Plastics are selected from the group comprising polyethylene, polypropylene and copolymers thereof, polybutylenetherephthalate, polyethylenetherephthalate, PVC, polystyrene, isobutylene-isoprene copolymer, polyisobutylene, and the like. It is understood that cables, cellophane and nylon are included in the plastics. The oils are selected from the group comprising oxidised oils, fuel oil, heavy oil, and the like. Preferably, tires, rubbers, plastics and liquid combustibles are used. More preferably, tires are used. All starting materials 110 previously treated may be subjected to the thermolysis 120 separately or mixed one with another.

In one embodiment, by employing rubbers, 90% to 94% of their organic matter is transformed into liquid hydrocarbons of a density comprised between 0.74-0.79 g/cm³, being the rest gaseous hydrocarbons having 1 to 5 carbon atoms. In another embodiment, by employing tires all components may be recycled with the method and the installation disclosed herein. Said components comprise the metal core, carbon black (carbon black with high surface area), cotton, nylon and metal fabrics, mineral fillers (stabilisers), additives, oils and rubber. In another embodiment, derivatives of cellulose, methyl methacrylate or carbamides may be employed, where the yield can be different according to the content of their organic matter, producing in these cases more gaseous than liquid hydrocarbons. In another embodiment, a yield of 90% is obtained with the oxidised oils, the fuel oil and heavy petroleum without the production of fuel oil, decreasing its density between 0.2 g/cm³ and 0.1 g/cm³, in accordance with the original density. The production of fuel oil is possible with the method herein disclosed but not planned, unless so desired. Moreover, it is noted that the fuel oil can be starting material as well as secondary product or final product. Without any doubt, use of the waste oils presents a very worthwhile method, which does not rule out pure or almost pure oils.

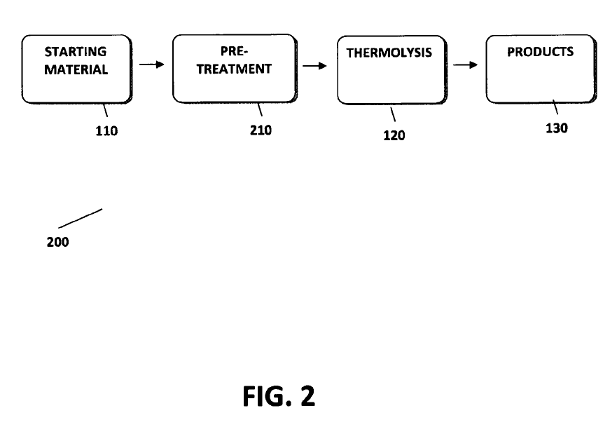

As can be seen from FIG. 2, in one embodiment, a pre-treatment 210 of the starting materials 110 may be necessary when these are not provided in appropriate size and purity.

The method and the installation may vary depending on the starting material 110.

In one embodiment, grinding and milling is performed, where the metal part is separated or not and the starting material (tires) is transformed with a catalytic and/or heat method into gaseous, liquids and semisolid hydrocarbons, such as waxes and tar, into carbon black and into inorganic oxides. In another embodiment, once milled, and with a catalytic and/or heat method, the starting materials (plastics) are cracked to obtain gaseous and liquid hydrocarbons and inorganic oxides. In another embodiment, for the cables, cellulose and nylon, the method may be a combination between the two previous embodiments.

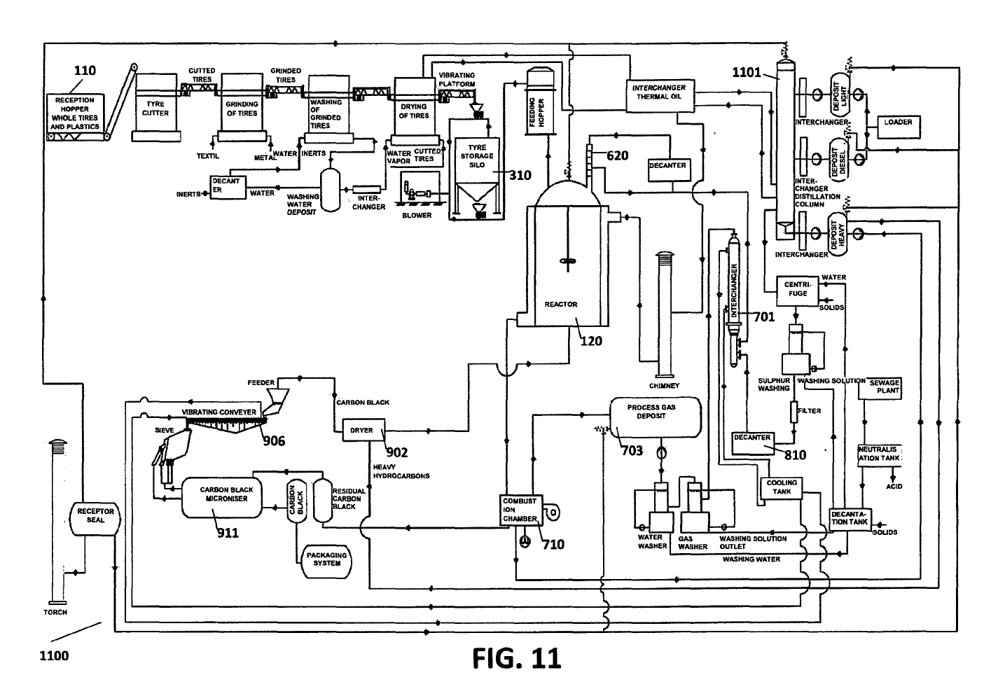

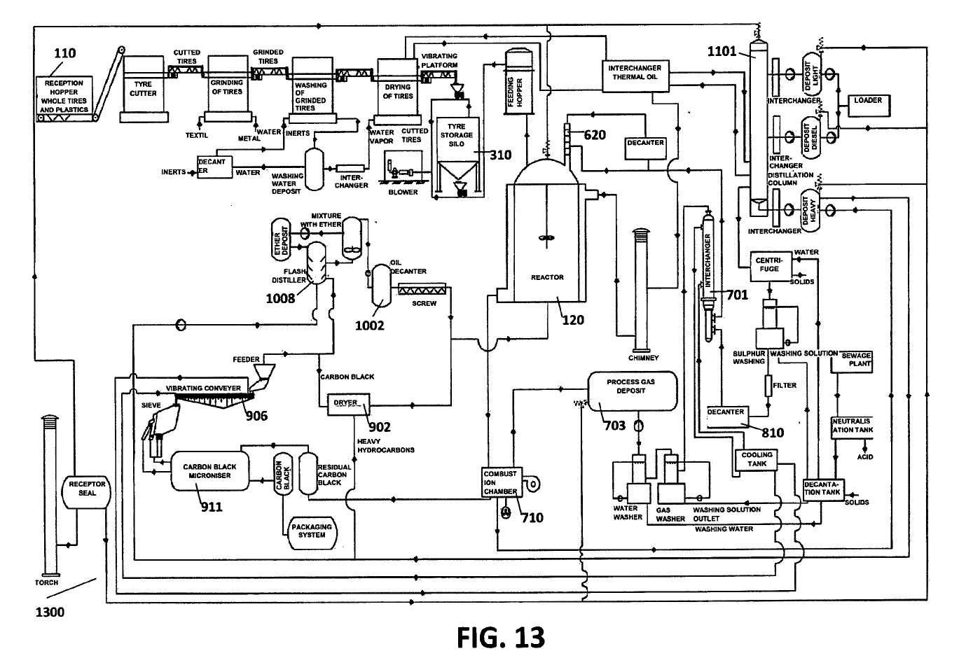

FIGS. 11 to 14 present overviews of embodiments of the present invention in more detail.

### Pre-Treatment

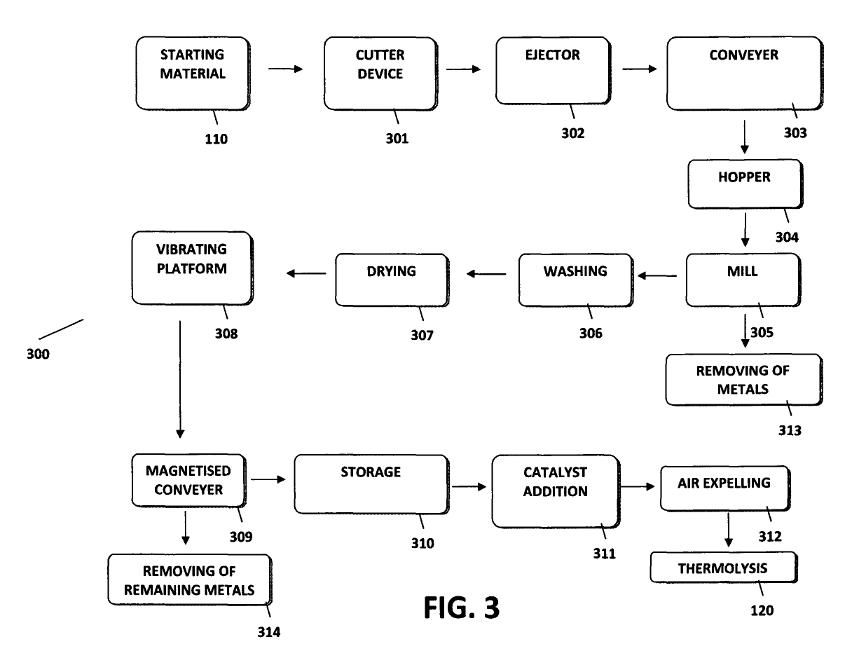

With reference to FIG. 3, the pre-treatment 210 is now explained in more detail.

The starting materials 110, preferably tires, rubbers plastics or oxidised oil, more preferably tires, have to be cut prior to thermolysis 120 when they cannot be provided in an appropriate size and/or purity. The preferred size of the solid starting materials is from 8 mm to 25 mm depending on the handling. A size smaller than 8 mm may still be useful for the present invention but results in higher costs making the recycling method less economical. A size greater than 25 mm is not useful because it still might contain greater metallic pieces. This metal on the one side could damage severely the joint elements between the distinct phases of the method and installation, and on the other side might involve a lower yield of the thermolysis products and a higher effort for purifying subsequently the solid secondary thermolysis products.

The starting material 110 in its entirety or separately enters first a cutter device 301 having cross cutters or in any other geometrical form that is operated hydraulically or electrically. This cutter device 301, for example a cutter, has the object to subdivide the material for a better transport. An ejector 302 of the “pusher” type of conventional functioning moves the material to a conveyer 303 that transports it to a hopper 304 located over a mill 305. In this mill 305 of the shredder type, said material is further downsized by grinding to the preferred size of from 8 mm to 25 mm. In these mills 305, shredder and hammer-type, the metals 313, that the starting material 110 might contain, are eliminated, especially the iron of the tire. Also, the fabric components may be eliminated in the case they would be present in the starting material 110.

Subsequently, the material in pieces is washed with water 306 to remove impurities deposited on the surface. Such impurities may be sand, silica, dust or the like. The washing water 306 is collected and transported to a recipient where it is decanted and the impurities are removed by filtering them off. The clean water is then stored in a deposit tank and can be re-used for washing 306 of fresh starting material 110. The solid impurities are removed into a container.

The wet starting material 110 then passes to a drying area 307. Said material is fed to the drying 307 by a screw conveyer having a slow velocity and a variable pitch. The drying area 307 is fed by two currents, one of hot air proceeding from the combustion chamber and the other of regeneration air originating from the blower. Thus, a drying 307 may be performed faster and more efficiently given that with two gas currents no water vapour saturation occurs in the air. Both currents, after passing and drying the wet material, are evacuated to the chimney using another blower to the recovering chimney of carbonate anhydride.

After drying, the material passes to a vibrating platform 308 where the remaining impurities are separated due to the different densities. Then, the material is transported on a magnetised conveyer 309 where in its final part it is demagnetised for removing the possible iron 314 that had remained in the material. The so obtained starting material 110 is free of impurities and metal components and stored 310 in containers, big-bags or in storage silos, preferably in storage silos, prior to thermolysis 120.

In one embodiment, this storage silo contains in its bottom industrial planetary extractors, ideal for continuous use and formed by:
a metallic beam diametric to the silo which contains all the necessary mechanisms for the rotation of the extraction bucket;
a central conical hood wherein the engines for the rotation of the bucket are installed and protected;
the pinions, the chains, the transmission organs and the running-in which guarantee the necessary working pairs, movements and turns to the extraction bucket;
conic frustum extraction bucket system having a shaft and spiral duly dimensioned for extracting the product towards the silo and empty it into the central metallic discharge hopper, with a condenser probe for protection against inundations (formation of vaults) in the hopper.

In one embodiment, just before feeding the treated starting material to the reactor, a conventional cracking catalyst 311 may be added and the air is removed 312 and replaced by an inert atmosphere. The catalyst permits performing a thermolysis method at lower temperatures and shorter reaction times than without such a catalyst. Furthermore, the catalyst favours the yield and reduces the undesired secondary products. However, the person skilled in the art will know that it is also possible to add the catalyst to the reactor. An inert atmosphere is necessary to avoid any detrimental oxidation reactions of the desired secondary products that might cause a reduction of the quality or, in the worst case, fires or explosions.

In this way, the main pre-treatment method 210 is finalised. Said pre-treatment may be appreciated also from the FIGS. 11 to 14, where the starting material enters the installation in 110, passes the afore-mentioned steps and is stored in 310.

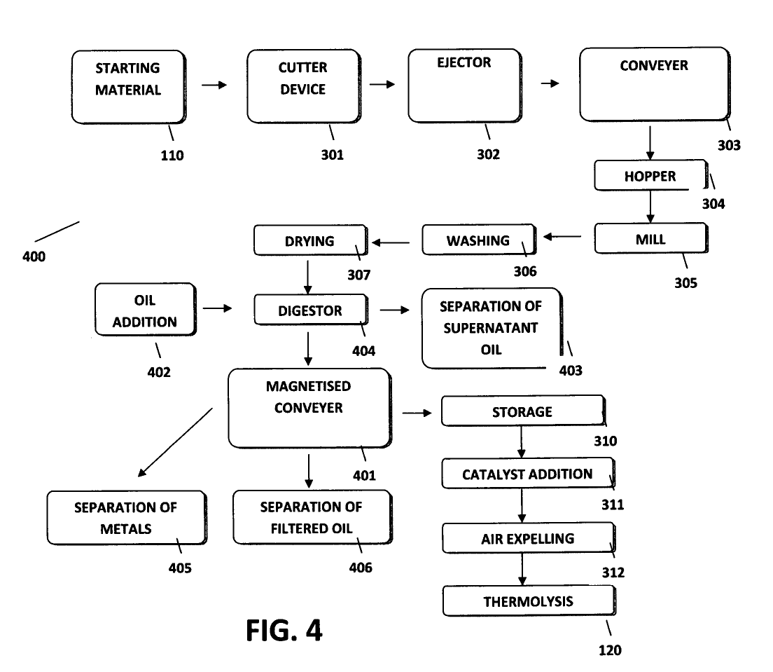

In an alternative embodiment, as can be appreciated from FIG. 4, the starting material 110 is transported after the drying 307 to a digester device 401 where said materials are mixed with oil 402 previously heated to a temperature of from 50° C. to 350° C. in said digester 401. The necessary heat may be provided from the hot air proceeding from the combustion chamber. The mixing with the hot oil 402 causes the initial material to swell and become spongy, resulting in the debonding and separation of the metal components from said material. This method may further benefit from the use of a stirring means. The digestion carried out depends on the temperature of the hot oil and the type of initial material and may vary typically between 15 minutes and 60 minutes. Supernatant oil 404 is then recovered either for subsequent digestions or as optional additive for the thermolysis 120. The starting material 110, impregnated with oil, leaves the digester 401 through an exit in the bottom and is discharged on a magnetic conveyor 404 which serves to separate the metal 405 and to filter off the remaining oil 406. Finally, the initial material is stored 310 prior to thermolysis 120. Said storing may be made in a storage silo or directly in the hopper that feeds the reactor. This may depend on the amount of starting material to be treated. The main advantage of this embodiment is that the step of digestion in oil allows softening of the primary material mass, allowing a more efficient, and thus faster, reaction. Another advantage is that filtering of metal component remains of reduced size is allowed, since they may be separated more easily from the mass.

The digester 401 comprises a hopper, a stirrer operated by an engine, a gas exit, an entry for adding the oil, an exit in the bottom for transporting the starting material 110 and an exit at liquid level to recover the supernatant oil 404.

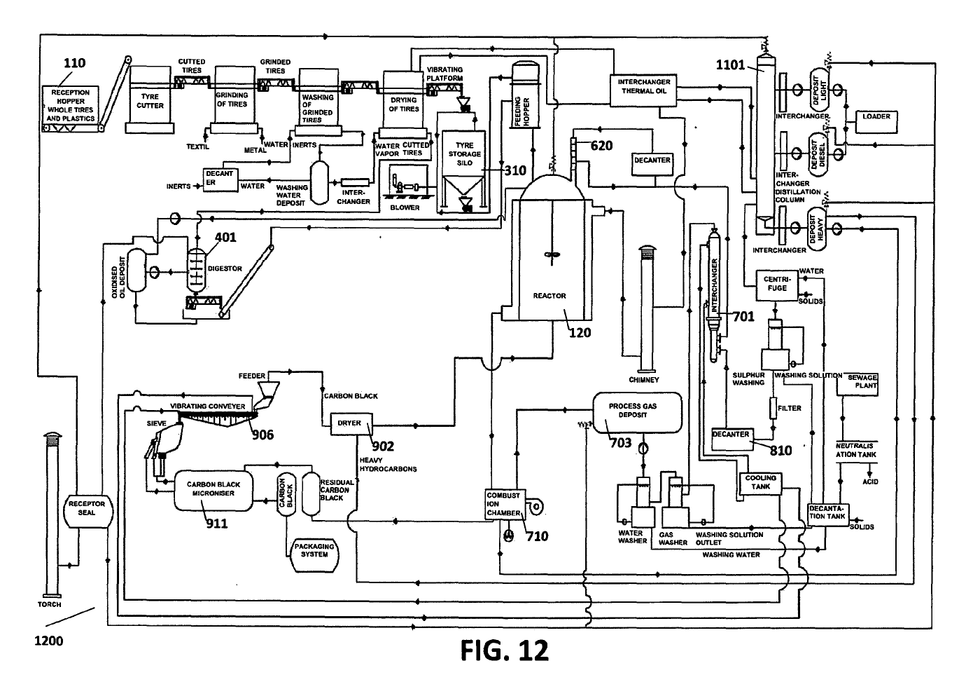

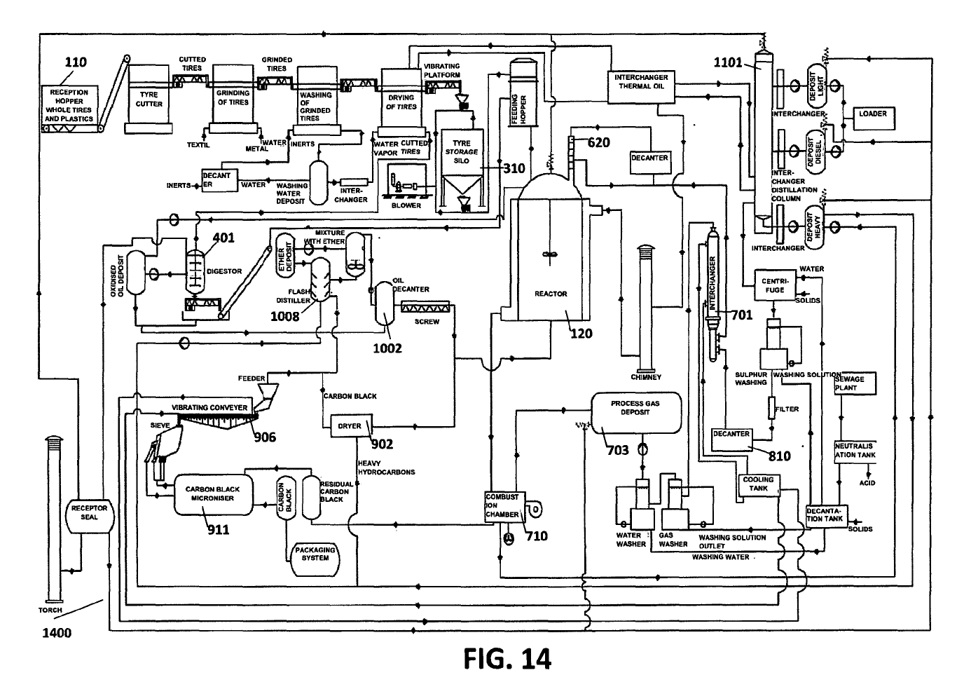

This alternative embodiment may also be appreciated in the diagrams of the FIGS. 12 and 14, wherein the digester 401 is indicated.

### Thermolysis

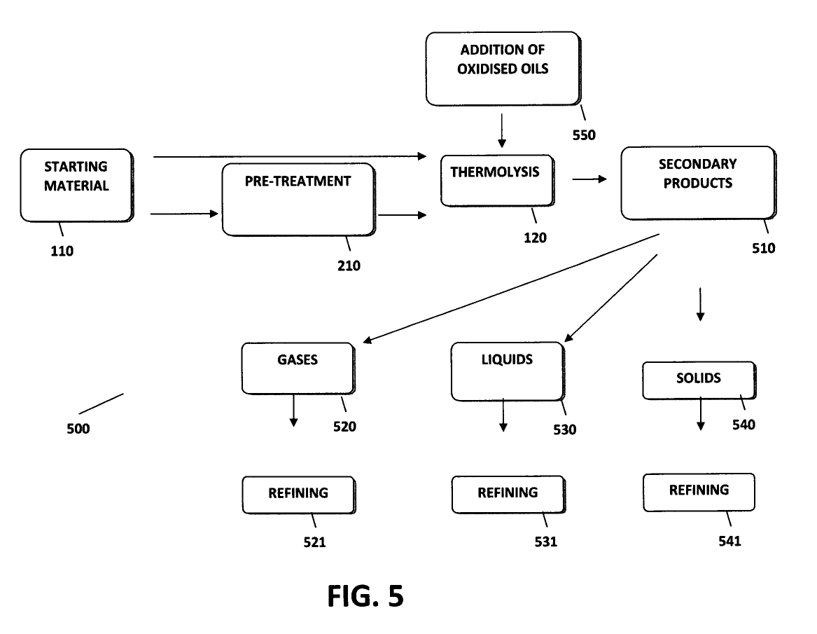

With reference to FIG. 5, having prepared the material 110 for the thermolysis 120 it may be added to the hopper feeding the reactor either from the storage silo or, if the pre-treatment 210 is not necessary, directly from big-bags through a blower and a rotary valve. In said hopper, said catalyst is added and the air is expelled. The expelled air, coming from the blower, is filtered by a sleeve filter to comply with the environmental law. The content of the hopper is then charged into the reactor and thermolysis 120 can start.

The reactor is located inside a heat system, preferably a heating jacket, which is able to provide indirect heating along the reactor. The heat is produced in a burner or combustion chamber to which mainly gaseous hydrocarbons are fed. However, also liquid hydrocarbons and/or carbon black may be used as combustibles. Said heat is brought towards the reactor by pipes. In one embodiment, the burner is fed with gaseous hydrocarbons, liquid hydrocarbons not having the desired quality for their subsequent external use and carbon black not having the desired quality for its subsequent external use. Hence, it is possible to burn three different components at the same time in the same triple burner. In one embodiment, said triple burner is fed with about 80% of gaseous hydrocarbons, about 10% of liquid hydrocarbons and about 10% of carbon black. The triple burner can be operated to heat one or more reactors. In one embodiment, from one to six thermolysis reactors may be heated at the same time using said triple burner.

The combustion air has a temperature which normally is too high for the purposes of the present invention due to the high energetic content of the combustibles. Hence, the combustion air to be used for heating of the thermolysis has to be controlled.

The heating temperature is regulated by adding an appropriate amount of air having a temperature lower than the necessary thermolysis temperature to the combustion air. Preferably, said air has ambient temperature. The desired temperature is controlled by various sensor means outside and inside the reactor.

Said reactor may be vertical, horizontal or inclined. In the upper part, the reactor may comprise various inlets, such as for example for the stirrer means, starting material, addition of additives when necessary, preferably oil, or sensor means to control temperature, pressure, oxygen content, etcetera, pressure control valve and the like. In one embodiment, the reactor is vertical. The secondary products can be extracted faster with a vertical reactor than with other configurations given that the path of the secondary product to the exit is shorter and that the principle of gravity may be used. Moreover, it is possible to build the installation in modules from bottom to top in a smaller room to place advantageously more than one reactor, together with the respective peripheral means that also require an indirect heating, in one single heating jacket. Another advantage consists in that the combination of the vertical reactor with the cracking column results in a higher effective height of the column where the molecular cracking is realised. This height allows for a faster and more efficient overall reaction.

In one embodiment, at least one reactor is used to carry out the thermolysis 120. However, the triple burner is able to heat between one and six reactors at the same time. Hence, more than one reactor may be used with which it becomes possible to treat more starting material or make the thermolysis faster and more efficient.

In one embodiment, a starting material 110 is mixed with oxidised oils 550. The oxidised oils 550 may be added already in a pre-treatment 210 or added directly to the reactor as additives. Said oil may be added if it is desired to change the result of the secondary product 510 of the thermolysis 120 of a certain starting material 110. The addition 550 may be in the range of about 3% to about 30% by weight, preferably from 5% to 15% by weight, of the total weight of starting material 110 introduced. It has been found that the addition of oil 550 allows controlling the composition and the yield of the final products with the advantage that, in case of starting material 110 of an unfavourable composition, for example a low light hydrocarbons result may be compensated by adding said oil. However, more than 30% by weight of oil gives as result a too high percentage of heavy hydrocarbons and is not desireable.

The reactor also comprises several exits such as for example for extraction of the products of the thermolysis. In the upper part of the reactor, there is placed a cracking column through which the resulting thermolysis gas comprising gaseous and liquid hydrocarbons leaves the reactor. In the lower part of the reactor, an exit valve is provided through which the solid secondary product 540 of the thermolysis 120 passes on to the drying device. In one embodiment, the exit valve is located in the bottom of the reactor and the solid secondary product 540 of the thermolysis 120 falls into the drying device.

As afore-mentioned, in one embodiment the thermolysis reaction may preferably be carried out in an inert atmosphere in presence of a catalyst.

The catalyst allows a thermolysis method being carried out at lower temperature and reaction times than without said catalyst. Moreover, the catalyst favours the yield and reduces undesired secondary products 510. However, the person skilled in the art knows that it is also possible to add the catalyst to the reactor. The inert atmosphere is necessary to avoid prejudicial oxidation reactions of the desired secondary products that might cause a decrease of the quality or, in the worst case, cause a fire or explosion.

Any conventional thermolysis or cracking catalyst may be used. In one embodiment, the catalyst amount depends on whether the starting material 110 already contains a certain quantity of said catalyst or not. In one embodiment, less than 0.1% of catalyst is used, preferably between 0.05% and 0.1% of organic and inorganic compounds comprising calcium and/or zinc. In any case, the catalyst amount is maintained low with the corresponding advantage that it is not necessary to carry out an additional separation step when purifying the solid product of the thermolysis.

The thermolysis temperature is preferably in the range of from 150° C. to 450° C. Said temperature is controlled on the one hand by the sensor means regulating the triple burner and on the other hand by using stirrer means inside the reactor. Said stirrer means are fixed vertically in the reactor, preferably fixed in the upper part of the reactor. Said stirrer is used to distribute the heat over the reactor and the reaction mixture as well as to homogenise said reaction mixture. By distributing the heat, the stirrer provides a uniform and constant temperature distribution over the whole mass and makes the mixture of the starting material homogeneous allowing a more efficient thermolysis reaction. Undesired side reactions or unpredictable product compositions may so also be prevented.

The stirrer means are controlled to operate at determined velocities which are necessary for an efficient thermolysis method. In one embodiment, the velocity of the stirrer is from 5 rpm to 50 rpm (rounds per minute). If the velocity is lower than 5 rpm, the starting material mixture is not stirred appropriately and no homogeneity is achieved resulting in a lower yield. If the velocity is higher than 50 rpm, the starting material mixture is stirred too vigorously and will stick to the walls of the reactor resulting in a lower yield.

During thermolysis 120, various secondary products 510 are formed. The secondary products 510 of highest quantity are hydrocarbons. These may be light or heavy gaseous hydrocarbons, paraffins, isoparaffins, olefins, naphtha, kerosene, gasoline and diesel oil. Usually, a mixture of these hydrocarbons is formed that has to be purified and separated. Under thermolysis conditions, mainly all hydrocarbons are in a gaseous state and form the thermolysis gas, although a small part of the heavy hydrocarbons formed cannot vaporise and remains in liquid form in the reactor. Moreover, other small molecules may be formed, as for example water, hydrogen, carbon dioxide and the like that will also be present in the gaseous state. This gaseous mixture comprises the thermolysis gas formed during the thermolysis 120. Moreover, solid secondary products 540 will form, mainly in the form of carbon black. Also, the inorganic compounds which were added to the starting materials 110 as additives and the residues of the catalyst will be part of the solid secondary product 540 and have to be removed during a subsequent refining method. Usually, the liquid heavy hydrocarbons that remain will adsorb to the carbon black due to its porous structure. Hence, a subsequent separation step has to be carried out.

### Refining

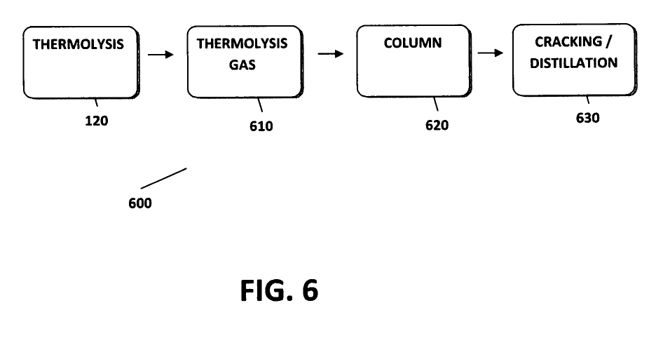

With reference to FIG. 6, during the thermolysis 120 a thermolysis gas 610 is produced comprising hydrocarbons which at ambient pressure and ambient temperature will be in gaseous and/or liquid state. Moreover, there may also be other small molecules present produced during the thermolysis 120 in said thermolysis gas 610, like for example hydrogen, water and the like. Said thermolysis gas 610 leaves continuously the reactor in the upper part of the reactor where the cracking column 620 is located.

The column 620 may present one or more exits along its length to remove selectively different types of hydrocarbons depending on their boiling point. In one embodiment, there is only one exit at the end of the column 620 for removing the final hydrocarbons formed. Hence, the thermolysis gas 610 has to pass through the whole column 620.

Said column 620 disposes of several plates in its interior which cause a further cracking 630 of the hydrocarbons. The plates are installed in series over the whole column 620 and form a set of plates that have a grating supported on a metal ring from which is hanging a sheet provided with holes. The set of plates forms a structure in the interior of the column 620 in such a manner that said collection is supported by a threaded bar passing through central openings and which bar has positioned in its upper part a sheet that is open in its interior provided with a central opening. The plates are formed by various conic frustrum tips exiting from the inner surface of the column 620 having different inclination angles. Moreover, said plates consist of some cartridges formed by a series of trays gradually superposed. Said trays are usually to about 75% superposed one over another. Moreover, each tray shows a series of staggered small cylindrical holes. It has been found that the structure of said sheets serves for cracking 630 and the fractioning distillation of the hydrocarbons to enrich determined hydrocarbons having between 5 to 15 carbon atoms and further to separate the carbon black particles that may be dragged with the current of the thermolysis gas 610 leaving the reactor.

In one embodiment, part or all of the thermolysis gas 610 leaving the cracking column 620 may be returned to said column 620. This may be possible before or after passing a decanter preconnected to the condenser having the effect of a filter and separating the dragged carbon black particles. All the hydrocarbons formed may be redirected without the temperature dropping too much, thereby not affecting the cracking of the recent formed thermolysis gas. Thus, the thermolysis gas 610 comprises a high proportion of hydrocarbons with a carbon atom number of between 5 to 15, in its majority saturated hydrocarbons and aromatics with few heavy hydrocarbons present. The plates inside the column 620 have the effect of condensing and vaporising the organic molecules over and over again at the thermolysis temperature inducing a thermal cracking 630 resulting finally in a desired hydrocarbon composition. The thermal cracking 630 occurs mainly with the heavier hydrocarbons due to their higher boiling point while the lighter hydrocarbons pass faster through the column 620. Hence, mainly hydrocarbons having a carbon atom number between 5 to 15 are formed.

### Gaseous Secondary Products

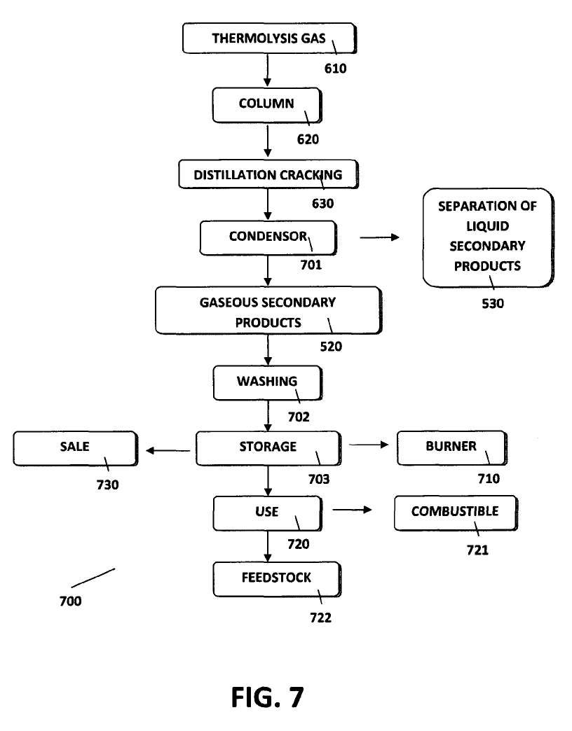

As can be appreciated from the FIG. 7, after leaving the cracking column 620 the cracked thermolysis gas 610 enters into a condenser 701. A refrigerating system which is part of the condenser 701 is set into operation so that it allows separating the gaseous hydrocarbons 520 having a carbon atom number of 1 to 4 from the liquid secondary hydrocarbons 530 having a carbon atom number higher than 4. Any condenser known in the art may be used. The refining of the so obtained liquid secondary hydrocarbons 530 is described in the following.

The gaseous hydrocarbons 520 separated in the condenser 701 comprise mainly hydrocarbons having a carbon atom number of from 1 to 4 and may additionally comprise hydrogen. The main components of said gaseous hydrocarbons 520 are methane, ethane, ethylene, propane, propylene, butane and isobutene and some light mercaptane. After leaving the condenser 701, the isolated gaseous hydrocarbons 520 are washed 702 to remove sulphur and chlorine ions and are finally stored 703 in, for example, a gasometer. The so obtained combustible gas may be used for the combustion in the triple burner 710 and establish the energetic autonomy of the installation. In one embodiment, the combustible gas may be introduced into the municipal gas supply network or otherwise be sold, for example as feedstock for polymer industry.

### Liquid Secondary Products

In one embodiment, said desired liquid light hydrocarbons 530 comprise the hydrocarbons having a carbon atom number of from 5 to 15, mainly saturated and/or aromatic. In another embodiment, said hydrocarbons have a carbon atom number of from 5 to 12. The components of said hydrocarbons may be of the type of paraffins, isoparaffins, olefins, naphtha, kerosene, gasoline or diesel depending on the starting material used. For example, tires will produce more synthetic diesel while plastics will give naphtha and kerosene.

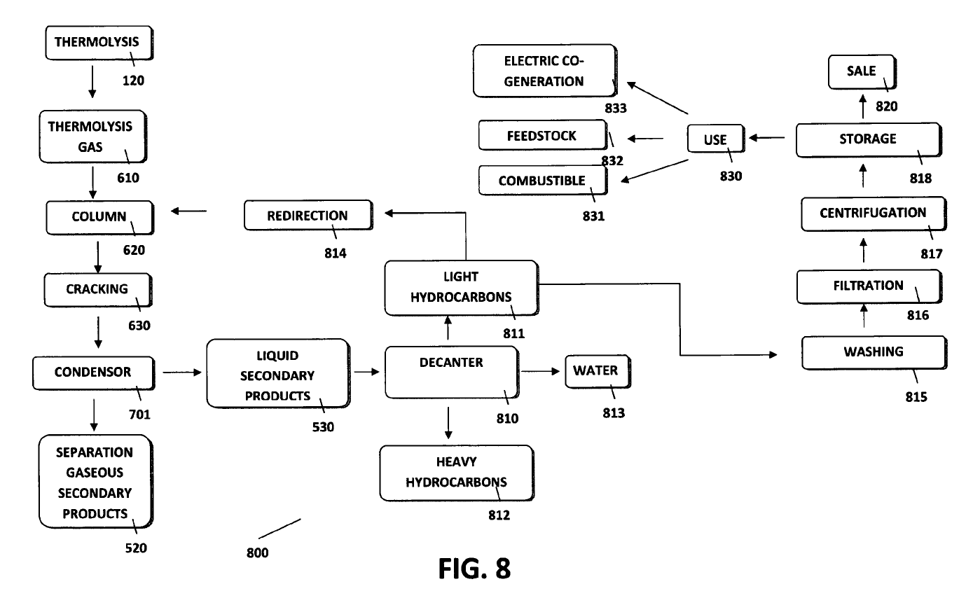

The refining of the liquid hydrocarbons is shown in FIG. 8. After the condenser 701, where the gaseous hydrocarbons are separated, the liquid hydrocarbons pass on to the decanter 810. The aim of the decanter is to separate the desired light hydrocarbons 811 from the heavy hydrocarbons 812 and from water 813. Any decanter known in the art may be used. The desired light hydrocarbons 811 are further processed and the water 813 and the heavy hydrocarbons 812 are collected each separately.

In one embodiment, part or all of the liquid hydrocarbons 530 are returned to the cracking column 620. This may be possible before or after passing the decanter 810. So, it is possible to redirect heavy 812 and light 811 hydrocarbons together or only the light hydrocarbons 811. Returning the liquid hydrocarbons 530 is necessary to guarantee that the final liquid product comprises hydrocarbons having a carbon atom number of between 5 and 15, in its majority saturated and aromatic hydrocarbons and of high quality without containing substantially any heavy hydrocarbon 812. When the liquid hydrocarbons 530 are returned to the column 620, they are heated to the thermolysis temperature and have to pass again through the whole cracking column 620. The effect of the plates of condensing and vaporising the organic molecules over and over again at the thermolysis temperature induces a thermal cracking 630 resulting finally in the desired hydrocarbon fractions. The thermal cracking 630 occurs mainly with the heavier hydrocarbons due to their higher boiling point while the lighter hydrocarbons pass faster through the column 620. Thus, said hydrocarbons having a carbon atom number of between 5 and 15 are enriched. Another advantage consists in reducing the amount of solid particles possibly dragged with by the thermolysis gas 610 and the final purification will be less laborious.

The final refining method of the light hydrocarbons 811 is as follows. After leaving the decanter 810, the light hydrocarbons 811 are washed 815, filtered 816 and centrifuged 817. In one embodiment, the so isolated light hydrocarbons 811 are then stored 818 for their sale 820 and/or use 830. The devices and techniques known in the art may be used.

In one embodiment, after leaving the centrifuge, part or all of the obtained liquid light hydrocarbons pass through a second column having conventional plates. In contrast to the cracking column 620 serving for the cracking of the thermolysis gas or the liquid hydrocarbons 530, this column has various exits with the effect that different fractions may be isolated and mixed to obtain a selectable diesel composition. Another effect is enriching the liquid light hydrocarbons in molecules having a carbon atom number between 5 and 12 and producing the desired diesel. It serves also as a purification step and it may be that heavy hydrocarbons still present will be separated. Said second column may be appreciated, for example, in the FIG. 11 indicated as 1101.

They may be used as such or can be blended with gasoline or diesel. In one embodiment, the light hydrocarbons may be used as combustible 831 in burners and industrial and automobile engines or to cogenerate energy 833 if desired. They may also be used as feedstock 832 or solvents in the chemical industry. In one embodiment, the light hydrocarbons may be used as combustible 831 for the triple burner to maintain the energetic autonomy of the plant when necessary.

In one embodiment, the heavy hydrocarbons 812 due to their poor quality are fed to the triple burner and contribute in this way to the energetic autonomy of the plant.

### Solid Secondary Products

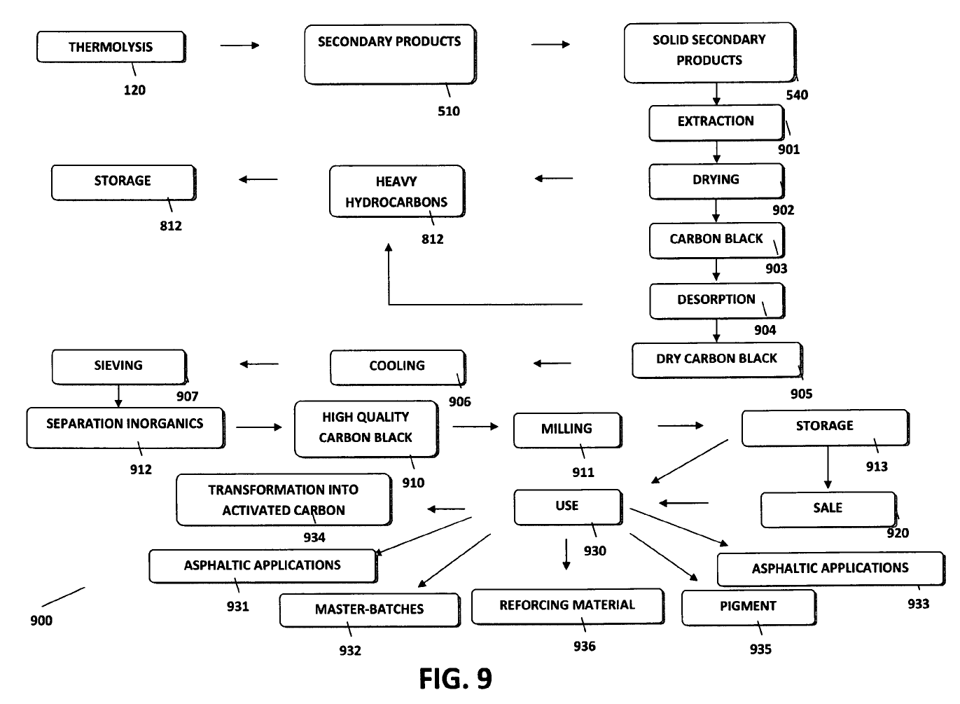

With reference to FIG. 9, when the thermolysis 120 has finished, the solid secondary products 540 of the thermolysis 120, preferably carbon black, remain in the reactor. Said solid secondary products 540 of the thermolysis 120 may be mixed with some liquid products of the thermolysis 120 which have not vaporized under the thermolysis conditions. Said liquid secondary products 530 of the thermolysis 120 normally tend to be adsorbed on the solid secondary products 540 of the thermolysis 120 and must be removed by drying 902, such as described subsequently.

The solid secondary products 540 of the thermolysis 120 are removed 901 from the reactor through an exit valve located in the lower part of the reactor. Preferably, said valve is located in the bottom of the reactor. So, when the thermolysis 120 has finished, said exit valve is opened and the solid secondary product 540 falls into the drying device 902. Once the reactor is emptied, the exit valve of the lower part of the reactor is closed and fresh starting material 110 may be added to the reactor to initiate another thermolysis reaction. Hence, the thermolysis of the present invention is carried out in a discontinuous manner.

The additional liquid secondary products 540 of the thermolysis 120 that have not vaporised and now are adsorbed on the solid secondary products 540 of the thermoplysis 120 comprise preferably heavy hydrocarbons 812. Said heavy hydrocarbons 812 may be removed applying sufficient heat during a determined time so that finally they vaporise and separate from the solid. This is carried out in a drying device 902, preferably located below the reactor. In this way, said drying device 902 is located within the same heating system as the thermolysis reactor and may benefit from the same indirect heating which is used for the thermolysis 120. In one embodiment, the drying device 902 is equipped with stirrer means that distribute the not dry carbon black over the whole dryer 902 which provides a better and faster removal of the adsorbed hydrocarbons.

After having desorbed from the solid secondary product 540, the heavy hydrocarbons 812 leave the drying device 902 through an exit in the upper part of the device, preferably in the ceiling, and may be collected in a separate deposit together with the heavy hydrocarbons isolated in the decanter 810. The substantially dry solid secondary products 540 leave the drying device 902 through an exit in the lower part of said device, preferably in the bottom.

Said solids 540 will then be transported by transportation means, preferably in form of a screw. Said screw may be covered by a heat system that may be the same or a different heat system than the one used for heating the reactor and the drying device 902. Said heat system keeps the substantially dry solid secondary products 540 at temperatures of from 130° C. to 350° C., preferably 150° C. to 270° C. This will allow removing the liquid residues that might still be adsorbed on the solid secondary products 540. At the end of said screw, all volatiles substances will exit through an exit leading to the deposit where the heavy hydrocarbons 812 are collected.

The now dry solid secondary products 540 are then cooled to ambient temperature by cooling means 906 for their subsequent purification. In one embodiment, the cooling means 906 comprise a platform with a heat exchanger system. The heat exchanger system might be operated with any medium, preferably cool air, water or other liquids, more preferably with water. The temperature of the cooling medium may be ambient temperature or lower. Other methods of the state of the art perform said cooling later in the refining with the disadvantage that the systems between exiting the reactor and cooling device require thermally strong and durable construction elements. The cooling prior to the purification steps allows the use of cheaper devices and where the maintenance is easier. Moreover, purification agents such as washing baths in different solvents may be used directly, something that would not be possible at elevated temperatures without taking certain precautions.

The platform 906, further to the heat exchange system, comprises a vibrating conveyer belt having various elevated elements on its surface that render said surface of the platform 906 irregular. Said elements are distributed all over the platform 906 and may be provided regularly or irregularly. Preferably, the elements are provided regularly, lined up or staggered. The height of said elements is not limited, as long as the possibility exists that the carbon black can pass above said elements. Preferably, said elements have the shape of a button. Said elements impart a higher surface area to said platform 906 making the cooling process more efficient given that the carbon black may be brought into contact with more cooling area. Said elements also make that the carbon black becomes spongier. The advantage thereof is a faster sieving since a material rendered spongy does not tend to become compressed.

After leaving said platform, the carbon black is sifted 907 to eliminate any impurity possibly remaining from the original starting material 110 such as for example cracking residues having an elevated fusion point that might not have suffered complete thermolysis 120. Next, the sifted carbon black may be washed in aqueous acid solution to eliminate the inorganic impurities 908 and the catalyst traces still present, or it may be milled 911 subsequently in microniser until a uniform average particle size. These two steps are interchangeable. For example, in one embodiment according to FIG. 9, first the removal of the inorganic particles is carried out and then the carbon black is milled, while in another embodiment, the step of milling is carried out before the removal of the inorganic particles. The so obtained carbon black is then stored for sale.

In one embodiment, the carbon black is used for asphaltic applications 931 or to manufacture master-batches 932 with polymeric products used in extrusion, injection and pressing of plastics and rubbers. Another of its applications is the use for fireworks 933. The carbon black may also be transformed into activated carbon 934 for its use as filter or absorption agent or for medical applications. It also has use in the production of new tyres, as a pigment 935, or as a reforcing material 936.

In one embodiment, the carbon black that has not the desired appropriate quality may be separated and fed to the triple burner 710, such as described before.

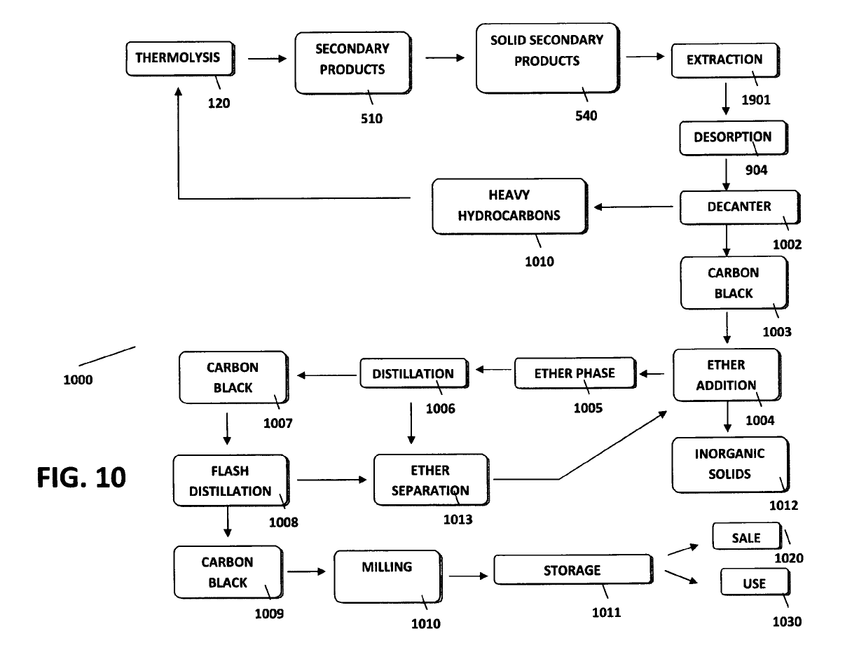

In one alternative embodiment, as can be appreciated from FIG. 10, the solid secondary products 540 resulting from the thermolysis 120 may be continuously removed from the reactor by a dissolution phase in ether and using a screw or the like. Said screw is located in the lower part of the reactor. Inert atmosphere is maintained. The solid secondary product 540 is kept at temperatures of from 130° C. to 350° C., preferably 150° C. to 270° C., using a heat exchanger. Said solid secondary products 540 are transported to a decanter tank 1002 where the adsorbed liquid secondary products 530 to said solid are separated and returned to the reactor using a pump. The step of dissolution in ether has the effect to liquidise the secondary products allowing a quicker separation.

Then, the inorganic impurities are separated. Therefore, said solid is transported to a recipient having a stirrer where an organic solvent is added 1004 comprising an ether group, preferably dietyl ether or diisopropyl ether. The organic portion, preferably heavy hydrocarbons 812, of said solids will dissolve in the solvent and carry away the carbon black while the inorganic portion will settle forming a suspension. After that, the inorganic substances 1012 may be decanted off. This separation method is normally performed at temperatures of from −70° C. to 20° C. The ether phase 1005 comprising the carbon black is transported to a first distillation device 1006 where the ether is removed 1013 by distillation and collected in a deposit for re-use in the later purification of fresh secondary solid products 540 of the thermolysis 120. The still remaining hydrocarbons 812 are also removed and then returned to the thermolysis reactor. The carbon black 1007 to which still some ether is adsorbed to is transported to a second distillation device wherein a flash distillation 1008 is carried out by introducing a current of inert gas previously heated in a heat exchanger fed by the gases coming from the combustion chamber 710. The effect of the flash distillation 1008 is the separation of the ether residues 1013 which leave by the head after passing a filter, typically a sleeve filter, and are returned to the first distillation device 1006. The dry carbon black 1009 is collected at the bottom of the second distillation device and falls through an exit in the bottom of said distillation device into a recipient where it is further treated as described before.

### EXAMPLES

The following tables show the results of different recycling methods obtained with different starting materials:

| | | | | |
|---|---|---|---|---|
| | | | | % over |
| Starting Material: | kg | Products | kg | org. mat. |

1. - Thermolysis of a plastic or a rubber without filler: Yield 98%

| | | | | |
|---|---|---|---|---|
| plastic/rubber | 100 | gaseous hydrocarbons | 6.0 | 6.1 |
| | | light hydrocarbons | 87.0 | 88.9 |
| | | heavy hydrocarbons | 4.8 | 4.9 |
| | | inorganics (oxides) | 0.2 | |

2. - Thermolysis of a filled plastic: Yield 98%

| | | | | |
|---|---|---|---|---|
| plastic filled at 20% | 100 | gaseous hydrocarbons | 7.0 | 9.4 |
| | | light hydrocarbons | 62.0 | 82.5 |
| | | heavy hydrocarbons | 6.0 | 8.1 |
| | | inorganics (oxides) | 23.0 | |

3. - Thermolysis of tires Yield 98%

| | | | | |
|---|---|---|---|---|
| tires | 100 | Metals | 14.0 | |
| | | gaseous hydrocarbons | 7.0 | 8.5 |
| | | light hydrocarbons | 19.0 | 23.1 |
| | | heavy hydrocarbons | 14.0 | 17.1 |
| | | inorganics (oxides) | 4.0 | |
| | | carbon black | 42.0 | 51.2 |

4. - Thermolysis of oxidised oils Yield 96%

| | | | | |
|---|---|---|---|---|
| oxidised oils | 100 | gaseous hydrocarbons | 3.0 | 3.1 |
| | | light hydrocarbons | 25.0 | 26.0 |
| | | heavy hydrocarbons | 68.0 | 70.1 |

As can be deduced from the results of the practical experiments carried out, the method and installation allow advantageously the production of carbon black in a higher quantity than originally exists in the starting material. The composition in carbon black in the tires for cars and trucks, which are the ones that are most abundant, is for the car of 13% to 17% and for truck tyre between 25% and 30%, these quantities vary depending on the manufacturer. Therefore, as average, the tires which are recycled have 20% of carbon black as content. As can be observed in section 3 of the example, the increase of carbon black is more than the double of its initial content. In this case, it is possible to extract about 52% of carbon black. Therefore, the characteristics of the invention allow the efficient rectification of the starting materials allowing its entire recycling and so increasing the quantity of produced carbon black.

1. Installation for recycling polymer-based materials by depolymerisation comprising
at least one reactor adapted to depolymerise polymer-based materials through thermolysis, wherein the at least one reactor is heated indirectly;
separation means adapted to separate the solid, liquid and gaseous secondary products;
redirection means adapted for redirecting a part of the secondary products to supply the reactor with energy; and
processing means adapted to process the remaining part of the secondary products to manufacture final products suitable for external use;
wherein by means of the redirection means and processing means it is assured that all of the starting polymer-based material is either consumed by redirecting to the reactor or refined to obtain solid, liquid and gaseous final products suitable for consumption or sale.

2. Installation according to claim 1 further comprising means for a pre-treatment prior to the depolymerisation of the polymer-based materials providing starting materials of a size of 8 mm to 25 mm, storage means for the final products and a burner.

3. Installation according to claim 2, wherein the burner is fed with gaseous, liquid and solid combustibles or a mixture thereof.

4. Installation according to claim 2, wherein the at least one reactor comprises a cracking column in the upper part and stirring means, a drying chamber for drying the solid secondary products.

5. Installation according to claim 4, further comprising a distillation column to enrich the liquid final products by cracking into hydrocarbons having a carbon atom number between 5 and 12.

6. Installation according to claim 4, wherein the at least one reactor further comprises in its upper part a feeding hopper and said feeding hoppers have means for adding a catalyst and means for expelling the air and establishing an inert atmosphere.

7. Installation according to claim 4, wherein the cracking column comprises various plates along the whole column forming a set of plates comprising sheets provided with holes, gratings and metallic rings.

8. Installation according to claim 2, wherein the starting material in a size of 8 mm to 25 mm does not have any metallic content.

9. Installation according to claim 2, wherein the installation also comprises means for digesting starting materials with hot oil.

10. Installation according to claim 7, wherein said plates comprise a grating supported on a metallic ring from which a sheet equipped with holes hangs and said plates form a set of plates forming a structure in the interior of the column so that the said set is supported by a threaded bar passing through some central holes and which bar locates in its upper part a plate that is open in its interior provided with a central opening; moreover said plates are formed by various conic frustum tips exiting from the inner surface of the column with different inclination angles, and said plates consist of some cartridges formed by a series of trays gradually superposed and which are normally superposed to about 75% one over the other and wherein each tray comprises a series of staggered small cylindrical holes.

11. Installation according to claim 4, wherein said drying chamber comprises stirring means to distribute uniformly the solid secondary product over the whole drying chamber.

12. Installation according to claim 2, wherein by means of the redirection means and processing means it is assured that sufficient combustible is produced to maintain it energetically autonomous.

13. Method for recycling polymer-based materials by depolymerisation comprising the steps of:
depolymerising by thermolysis in at least one reactor wherein the at least one reactor is heated indirectly;
separating the solid, liquid and gaseous secondary products;
redirecting a part of the secondary products to supply energy to the reactor; and
processing the remaining part of the secondary products to manufacture final products suitable for external use;
wherein all the polymer-based starting material is either consumed by the redirecting to the reactor or is refined to obtain solid, liquid and gaseous final products suitable for consumption or sale.

14. Method according to claim 13, further comprising the steps of pretreating the polymer-based material, the pre-treatment comprising the steps of milling, washing, and magnetic separation, and cracking a part of the secondary products in a cracking column after the thermolysis.

15. Method according to claim 14, wherein the step of thermolysis is a batch-wise process.

16. Method according to claim 14, wherein part of the secondary products is redirected to the cracking column.

17. Method according to claim 14, wherein the thermolysis is carried out in the presence of a catalyst and inert atmosphere.

18. Method according to claim 17, wherein the catalyst comprises 0.1% or less of organic and inorganic compounds comprising calcium and/or zinc.

19. Method according to claim 14, wherein the thermolysis is carried out in a temperature range of about 150° C. to about 450° C.

20. Method according to claim 19, wherein the thermolysis is effected at a uniform temperature controlled by the stirring means.

21. Method according to claim 14, wherein between 3% and 30% by weight of an oxidised oil is added to the starting material.

22. Method according to claim 14, wherein the step of processing the secondary products of the liquid and gaseous products comprises the steps of:
separating the solid products;
additional distilling/cracking in a cracking column;
returning part of the hydrocarbons to the cracking column;
condensing the liquid hydrocarbons; and
separating the gaseous hydrocarbons.

23. Method according to claim 22, wherein processing the remaining part of the secondary products comprises further the steps of:
separating the liquid hydrocarbons into light and heavy hydrocarbons;
returning part of the light hydrocarbons to the cracking column; and
purifying finally by washing, filtering and centrifugation.

24. Method according to claim 14, wherein processing the remaining part of the solid secondary products comprises the steps of:
drying;
removing the remaining adsorbed heavy hydrocarbons;
cooling the solid product to ambient temperature;
removing the inorganic impurities;
sifting; and
milling.

25. Method according to claim 24, wherein the removal of the inorganic impurities is carried out using a treatment in an acidic bath or with an organic solvent comprising an ether group.

26. Method according to claim 14, wherein the pre-treatment further comprises a digestion step by mixing the initial material with hot oil.

27. Method according to claim 14, wherein the initial materials are selected from the group comprising plastics, rubbers, tires, cables, celluloses, cellophanes, nylon, heavy oils, fuel oil, oxidised oils, vegetal oils, vegetal material or mixtures thereof.

28. Product obtained by the method according to claims 13 to 27 or the installation according to claims 1 to 12, wherein the product comprises one of metal, carbon black, gaseous hydrocarbons and liquid light hydrocarbons having a carbon atom number of 5 to 15.

29. Product according to claim 28, wherein the light liquid hydrocarbons comprise gasoline, diesel, fuel oil, or mixtures thereof.

30. Use of the diesel product of claim 29 for its combustion in industrial and automobile engines or burners, for the co-generation of energy or as feedstock in the chemical industry.

31. Use of the carbon black product of claim 28 in asphaltic applications or mixtures, in the manufacture of master-batches with polymeric products utilised in extrusion, injection and pressing of plastics and rubbers, in fireworks, as pigment, as reforcing material, or in its transformation into activated carbon.

32. Use of the gaseous hydrocarbons product of claim 28 as combustible or feedstock in the chemical industry, preferably in the synthesis of polymers.
